(19) United States
(12) Patent Application Publication
(10) Pub. No.: US 2026/0031751 A1
(43) Pub. Date: Jan. 29, 2026

(54) MOTOR DRIVE SYSTEM AND MOTOR DRIVE METHOD

(71) Applicant: TMEIC CORPORATION, Tokyo (JP)

(72) Inventor: Shunsuke TOBAYASHI, Tokyo (JP)

(73) Assignee: TMEIC CORPORATION, Tokyo (JP)

(21) Appl. No.: 19/099,352

(22) PCT Filed: Mar. 9, 2023
(86) PCT No.: PCT/JP2023/009049

§ 371 Date: Jan. 28, 2025

(51) Int. Cl. H02P 23/14; G01B 7/30

(52) U.S. Cl. CPC H02P 23/14; G01B 7/30

(57) ABSTRACT

A power conversion device according to an aspect of the embodiment is a power conversion device in which a delay time occurs from a first timing of updating a detection result of a position of a motor using a position sensor by outputting the detection result of each position of the motor in each first period from the position sensor to a second timing of acquiring position information of the motor in each second period within a control cycle of the motor. The power conversion device includes a compensation amount adjustment unit and a control unit. The compensation amount adjustment unit counts time from the first timing to the second timing and generates a compensation value for compensating for the position information based on the counting result. The control unit performs position control on the motor based on the position information as a result of compensation and position command information of the motor.

### TECHNICAL FIELD

Embodiments of the present invention relate to a motor drive system and a motor drive method.

### BACKGROUND ART

A motor drive system detects a position of a motor using a position sensor and controls the position of the motor. In general, a control cycle of the motor is set to be longer than a period during which the position sensor outputs the position detection result for updating. However, the delay time between the output of the position detection result by the position sensor and the acquisition of the detection result for each control cycle may influence when insuring the responsiveness and stability in motor control. When the size of this delay time is irregular, it is difficult to reduce its influence. In motor control, it has been desired to reduce the influence of the delay time.

### CITATION LIST

### Patent Document

[Patent Document 1]

International Publication No. 2021/149187 pamphlet

### SUMMARY OF INVENTION

### Technical Problem

An object of the present invention is to provide a motor drive system and a motor drive method capable of reducing an influence of a delay time from a timing of outputting a detection result of a position of a motor using a position sensor to a timing of updating the detection result every control cycle.

### Solution to Problem

A motor drive system according to an aspect of the embodiment is a motor drive system in which a delay time occurs from a first timing of updating a detection result of a position of a motor using a position sensor by outputting the detection result of each position of the motor in each first period from the position sensor to a second timing of acquiring position information of the motor in each second period within a control cycle of the motor. The motor drive system includes a compensation amount adjustment unit and a control unit. The compensation amount adjustment unit counts time from the first timing to the second timing and generates a compensation value for compensating for the position information based on the counting result. The control unit performs position control on the motor based on the position information as a result of compensation and position command information of the motor.

### BRIEF DESCRIPTION OF DRAWINGS

FIG. 1A is a configuration diagram of a motor drive system of a first embodiment.

FIG. 1B is a configuration diagram of a calculation unit of the first embodiment.

FIG. 1C is a configuration diagram of a compensation amount adjustment unit of the first embodiment.

FIG. 2 is a diagram for illustrating position compensation amount adjustment of the first embodiment.

FIG. 3 is a diagram for illustrating position compensation amount adjustment of a modified example of the first embodiment.

FIG. 4A is a configuration diagram of a motor drive system of a second embodiment.

FIG. 4B is a configuration diagram of a calculation unit of the second embodiment.

FIG. 4C is a configuration diagram of a compensation amount adjustment unit of the second embodiment.

### DESCRIPTION OF EMBODIMENTS

Hereinafter, a motor drive system and a motor drive method of the embodiment will be described with reference to the drawings. Furthermore, in the following description, the same reference numerals are given to components having the same or similar functions. Then, duplicate descriptions of those configurations may be omitted. Furthermore, electrical connection is sometimes simply called “connection”. In the following description, “the sizes are the same” includes cases where the sizes are substantially equal.

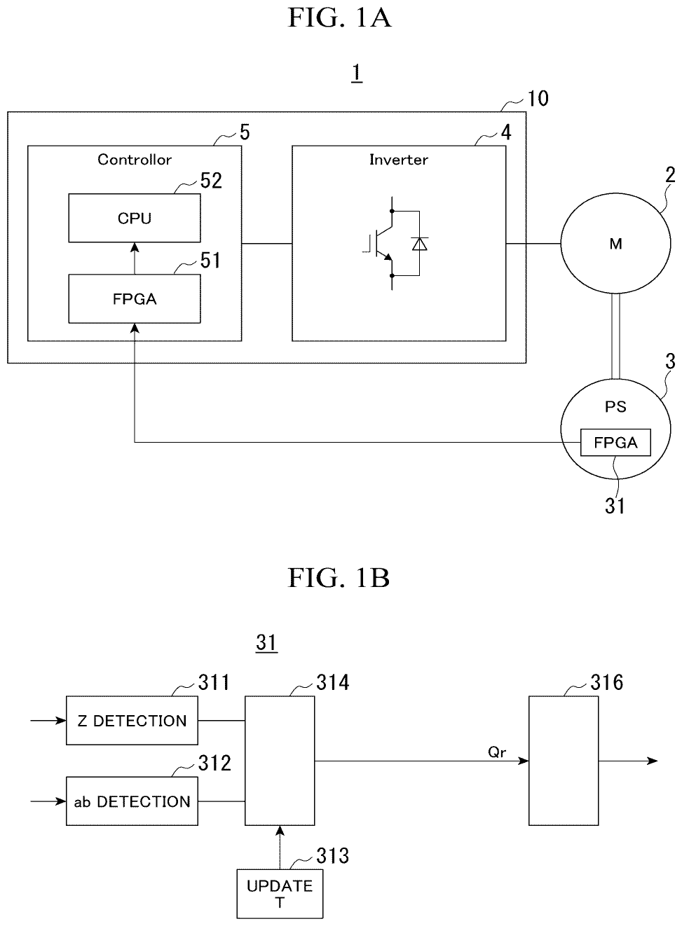

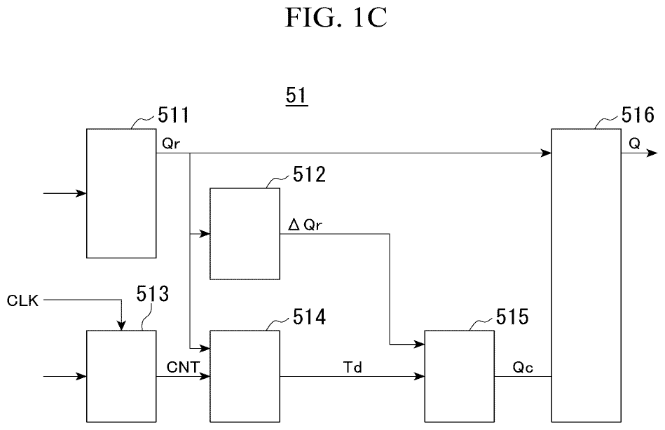

FIG. 1A is a configuration diagram of a motor drive system 1 of a first embodiment.

FIG. 1B is a configuration diagram of a calculation unit 31 of the first embodiment.

FIG. 1C is a configuration diagram of a compensation amount adjustment unit 51 of the first embodiment.

The motor drive system 1 includes, for example, a motor 2, a position sensor 3, and a power conversion device 10.

The motor 2 (described as M in FIG. 1A) is, for example, an AC motor including a plurality of windings. The windings of each phase of AC are respectively connected to the output of the power conversion device 10, which will be described later. The power conversion device 10 supplies AC power to the motor 2. This AC power rotates the motor 2. For example, the shaft of the position sensor 3 (described as PS in FIG. 1A) is mechanically connected to the shaft of the motor 2, and the shaft of the position sensor 3 rotates in conjunction with the rotation of the shaft of the motor 2.

The position sensor 3 detects the absolute position of the shaft of the motor 2. The position sensor 3 is an example of an absolute encoder. This position sensor 3 calculates the absolute phase and outputs the absolute phase.

The power conversion device 10 is connected to the motor 2 and the position sensor 3. The power conversion device 10 controls the motor 2 so that the actual position of the shaft of the motor 2 detected by the position sensor 3 matches the position corresponding to the separately supplied position command value.

As shown in FIG. 1B, the position sensor 3 includes a position sensor body and the calculation unit 31 (described as FPGA: Field-Programmable Gate Array in FIG. 1A).

The calculation unit 31 of the position sensor 3 includes, for example, a z position detection 311, an ab position detection 312, an update cycle generation unit 313, a position information calculation unit 314, and an output unit 316.

The z position detection 311 of the position sensor 3 detects an absolute position using the position sensor body, and outputs absolute position information accompanying this detection.

The ab position detection 312 of the position sensor 3 detects a relative position using the position sensor body, and outputs relative position information accompanying this detection.

The update cycle generation unit 313 generates a period for periodically updating the position information detected by the position sensor 3 and a timing signal for outputting the position information.

The position information calculation unit 314 uses the timing signal supplied from the update cycle generation unit 313 to periodically generate current position information Qr.

The output unit 316 includes an interface for communicating with an external device. The output unit 316 outputs the position information Qr through serial communication. The type of signal output by the output unit 316 may be an optical signal or an electrical signal.

The power conversion device 10 includes an inverter 4 and a controller 5.

The inverter 4 is an example of a power conversion device in which a plurality of semiconductor switches are formed in a bridge type. For example, the inverter 4 converts DC power supplied from a DC power source (not shown) into AC power, supplies the AC power to the motor 2, and drives the motor 2.

The controller 5 is a control device for the inverter 4 which drives the motor 2.

The controller 5 includes, for example, the compensation amount adjustment unit 51 (described as FPGA in FIG. 1A) and a CPU 52.

The CPU 52 is a computer which includes, for example, a processor which executes predetermined arithmetic processing by executing a program, a semiconductor memory, a drive circuit for the inverter 4, a clock, and the like. The compensation amount adjustment unit 51 as a peripheral circuit is connected to the CPU 52. The CPU 52 includes a position control unit which acquires the position information generated by the compensation amount adjustment unit 51 and performs position control based on the position information, a current control unit which adjusts the current flowing based on the result of position control, a PWM control unit which performs PWM control to cause the inverter 4 to supply power based on the result of current control, and the like. A general method may be applied to each process related to position control, current control, PWM control, etc. of the motor 2 by the CPU 52.

Referring to FIG. 1C, an example of the compensation amount adjustment unit 51 of the controller 5 will be described.

The compensation amount adjustment unit 51 includes, for example, an interface 511, a differential position information generation unit 512, a control cycle generation unit 513, a delay time information calculation unit 514, a compensation amount calculation unit 515, and a compensation calculation unit 516.

The interface 511 includes a receiving circuit which receives signals from position sensor 3. The signal from the position sensor 3 is, for example, a serial communication signal, and includes position information which is periodically transmitted. The interface 511 extracts periodically transmitted position information Qr from the signal received from the position sensor 3 and outputs the position information. The position information Qr corresponds to the position information output by the position sensor 3.

The differential position information generation unit 512 derives a position change amount ΔQr caused by updating the position information Qr based on the position information Qr output by the interface 511. The differential position information generation unit 512 calculates the position change amount ΔQr in response to the timing at which the position sensor 3 outputs the position information, in other words, the timing at which the position information is received from the position sensor 3. Furthermore, the differential position information generation unit 512 outputs the position change amount ΔQr as time history information.

The control cycle generation unit 513 is a timer which defines the control calculation period (control cycle) of the power conversion device 10. The control cycle generation unit 513 includes a counter capable of counting the time width of the control cycle. The control cycle generation unit 513 receives a clock CLK with a period Tc generated in the controller 5, counts this clock CLK with its counter, and outputs a count value CNT of the counting result. The control cycle generation unit 513 clears the count value CNT when reaching a predetermined upper limit value and restarts counting. The count value CNT output by the control cycle generation unit 513 is associated with a phase within the control cycle.

The delay time information calculation unit 514 samples and holds the count value CNT output by the control cycle generation unit 513 in synchronization with the receiving timing of the position information Qr. The delay time information calculation unit 514 subtracts the value of the count value CNT held by this sampling from the value of the control cycle Ti to calculate a delay time Td.

The compensation amount calculation unit 515 calculates the compensation amount Qc using the position change amount ΔQr and the delay time Td. This will be described later.

The compensation calculation unit 516 generates position information Q based on the position information Qr output from the interface 511 and the compensation amount Qc calculated by the compensation amount calculation unit 515. This position information Q has been compensated for the influence of the delay time Td.

Absolute phase information output from the position sensor 3 is periodically sent to the power conversion device 10 configured as described above through serial communication. The power conversion device 10 periodically receives the position detection result and holds the position detection result until the next reception. When the power conversion device 10 receives the detection result of the next position, the power conversion device updates the detection result held so far and repeats this process.

By the way, the sampling time of the control cycle of the motor 2 may arrive during the period in which the position detection results are held. In this case, the power conversion device 10 uses the held position detection results to control the position of the motor 2. Furthermore, the sampling time of the control cycle is the timing at which various information indicating the situation such as the position of the motor 2 is acquired in order to control the motor 2.

Furthermore, in the case of the comparative example, the detection results are updated periodically as described above, and are used for the position control described above after a delay from the time when the phase indicated by the absolute phase is detected. The delay time Td occurs from the update of this detection result to the sampling timing for use in position control.

The power conversion device 10 of this embodiment compensates for the delay which occurs in this control cycle. This will be described in detail.

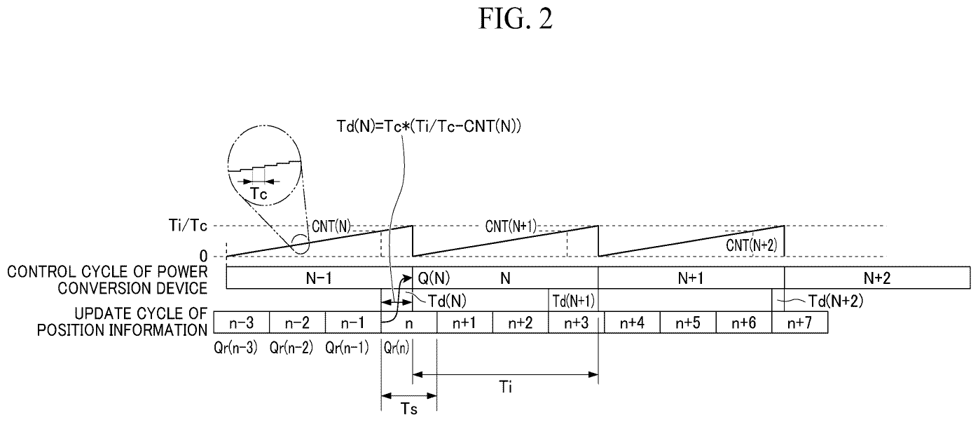

Referring to FIG. 2, the position compensation amount adjustment of the first embodiment will be described.

FIG. 2 is a diagram for illustrating the position compensation amount adjustment of the first embodiment.

In the timing chart shown in FIG. 2, the phase of the control cycle, the control cycle of the power conversion device, and the update cycle of position information are shown from the top. The horizontal axis of this timing chart shows the passage of time.

A continuous triangular wave is shown in the “phase of control cycle” at the top of FIG. 2. The amplitude of each triangular wave indicates the phase of the control cycle. The amplitude of this triangular wave is the result of counting by the control cycle generation unit 513. Strictly speaking, a triangular wave which appears to be changing continuously changes its value in a stepwise manner. In this way, it can be considered that the output is changing continuously by setting the quantization level of the output of the control cycle generation unit 513 to be relatively dense.

The second row from the top of FIG. 2 shows the period and phase of the control cycle in which calculations for various controls of the power conversion device 10 are performed. This figure depicts four consecutive control cycles identified using (N−1), (N), (N+1), and (N+2) as identification indicators.

The third row from the top of FIG. 2 shows the period and phase of the period in which the position sensor 3 outputs the detection result of the absolute phase. This figure shows eleven continuous update cycles which are identified using (n−3), (n−2), (n−1), (n), (n+1), (n+2), (n+3), (n+4), (n+5), (n+6), and (n+7) as identification indicators.

The detection results obtained at each update cycle are shown in the third row. For example, the detection results obtained at update cycles of (n−3), (n−2), (n−1), and (n) are sequentially Qr(n−3), Qr(n−2), Qr(n−1), and Qr(n).

Among these, the sampling timing of the control cycle (N), which is the next control cycle, occurs within the period of the update cycle (n).

The time from the start timing (first timing) of the update cycle (n) to the sampling timing (second timing) of the control cycle (N) is called a delay time Td (N). The delay time Td (N) corresponding to the control cycle (N) is defined by the following formula (1).

$$Td ( N ) = Tc * ( Ti / Tc - CNT ( N ) ) \qquad ( 1 )$$

“CNT(N)” in the above formula (1) is a count value by the counter at the start timing of the period of the update cycle (n).

Similarly to the above, the sampling timing of the control cycle (N+1) occurs within the period of the update cycle (n+3). The time (time difference) from the start timing of the update cycle (n+3) to the sampling timing of the control cycle (N+1) is called a delay time Td(N+1). The count value by the counter at the start timing of the update cycle (n+3) is written as CNT(N+1).

Further, the sampling timing of the control cycle (N+2) occurs within the period of the update cycle (n+7). The time (time difference) from the start timing of the update cycle (n+7) to the sampling timing of the control cycle (N+2) is called a delay time Td(N+2). The count value by the counter at the start timing of the update cycle (n+7) is written as CNT(N+2).

Hereinafter, the derivation of the delay time Td for each control cycle will be described in more detail by associating the sampling timing of each control cycle with the start timing of each control cycle.

The power conversion device 10 is required to perform control calculation for driving the motor 2 in a predetermined control cycle (referred to as control cycle Ti) based on the phase of the motor 2 at a predetermined point in time within the control cycle Ti. For example, a predetermined point in time within the control cycle Ti is associated with the start timing of the control cycle Ti.

Furthermore, it is assumed that the phase update cycle of the position sensor 3 and the communication period of serial communication are asynchronous with the control cycle Ti of the power conversion device 10. According to this condition, a delay occurs before the position information received by the power conversion device 10 is used for position control calculations. Therefore, an error will occur in the position indicated by the position information received by the power conversion device 10 due to the calculation in discrete time with respect to the actual position at the time of use for position control calculation.

Furthermore, the phase update cycle of the position sensor 3 is synonymous with the update cycle of position information of the position detected by the position sensor 3.

### Adjustment of Control Cycle Ti of Power Conversion Device 10

For example, the control cycle Ti of the power conversion device 10 is determined depending on the application of the applied system. In this case, if necessary, the control cycle Ti may be changed from the standard value within the permissible range.

In the position sensor 3 of the embodiment, the phase update cycle and the communication period of serial communication with the power conversion device 10 are set in advance, and these cannot be changed. Therefore, even if the control cycle Ti of the power conversion device 10 is adjusted as described above depending on the application of the applied system, the phase update cycle of the position sensor 3 and the communication period of serial communication with the power conversion device 10 cannot be changed according to the adjustment of the control cycle Ti of the power conversion device 10.

In this embodiment, the power conversion device 10 compensates for this influence.

### Relationship Between Control Cycle Ti of Power Conversion Device 10 and Phase Update Cycle of Position Sensor 3

It is assumed that the phase update cycle of the position sensor 3 and the communication period of serial communication are sufficiently fast with respect to the control cycle Ti of the power conversion device 10.

Furthermore, in order to simplify the description, it is assumed that the position sensor 3 updates the phase and immediately transmits the phase to the power conversion device 10, and the period thereof is assumed to be Ts. In other words, as shown in FIG. 2 above, the phase information is updated at the update cycle Ts. The CPU of the power conversion device 10 performs control calculations at the control cycle Ti. In this way, the relationship (Ti>Ts) satisfies that the control cycle Ti is longer than the update cycle Ts. Furthermore, if these magnitude relationships are reversed (Ti<Ts), the power conversion device 10 cannot function. Therefore, the consideration and description of this condition will be omitted.

### Method of Identifying Phase Within Control Cycle Ti of Power Conversion Device 10

The power conversion device 10 counts within the control cycle Ti of the power conversion device 10 using a period shorter than the update cycle Ts as a unit time.

For example, the control cycle generation unit 513 of the power conversion device 10 has a counter which sets the numerical value at the start of the period of the control cycle Ti to 0 and counts up the clock CLK as time passes. The repetition period of the clock CLK becomes the period Tc.

For example, the control cycle generation unit 513 sets this count CNT to 0 at the beginning of the next control cycle Ti. The control cycle generation unit 513 changes the count CNT between 0 and (Ti/Tc) by repeating counting from the start of the period of the control cycle Ti. By constantly performing this counting, the control cycle generation unit 513 uses the count CNT as information indicating the phase within the control cycle Ti. The control cycle generation unit 513 of the power conversion device 10 records the count CNT of the timing at which the position information Qr is updated together with the position information Qr.

### Derivation of Delay Time Td

At the start of the next control cycle Ti, the differential position information generation unit 512 of the power conversion device 10 uses the last updated count CNT to calculate the delay time Td indicating how much time has passed since the last updated position information Qr was transmitted or received. The above formula (1) can be applied to this calculation. Furthermore, the relationship shown in formula (1) ignores the influence of delays and fluctuations due to serial communication.

### Derivation of Compensation Amount for Delay Time Td

The differential position information generation unit 512 of the power conversion device 10 calculates the phase change amount ΔQr for each update cycle Ts using the time history information of the position information Qr. The compensation amount calculation unit 515 calculates the compensation amount Qc of the position information Qr using the delay time Td and the phase change amount ΔQr for each update cycle Ts.

The compensation calculation unit 516 generates the compensated position information Q based on the position information Qr and the compensation amount Qc calculated by the compensation amount calculation unit 515. For example, the compensation calculation unit 516 may calculate the corrected phase Q(N) by adding the compensation amount Qc to the latest sampling phase Qr(n). This relationship is shown in the following formulas (2-1) to (2-3).

$$Δ Qr = Qr ( n ) - Qr ( n - 1 ) \qquad ( 2 - 1 )$$

$$Qc = Δ Qr * Td / Ts \qquad ( 2 - 2 )$$

$$Q ( N ) = Qr ( n ) + Qc \qquad ( 2 - 3 )$$

According to the above-described embodiment, the motor drive system 1 is a power conversion device in which the delay time Td occurs from the first timing of updating the detection result of the position of the motor 2 using the position sensor 3 by outputting the detection result of each position of the motor 2 in each first period from the position sensor 3 to the second timing of acquiring position information of the motor 2 in each second period within the control cycle of the motor 2. The motor drive system 1 includes the compensation amount adjustment unit 51 and the CPU 52 (control unit). The compensation amount adjustment unit 51 counts the time (time difference) from the first timing to the second timing, and generates a compensation value for compensating for the position information based on the counting result. The CPU 52 performs position control on the motor 2 based on the position information as a result of compensation and the position command information of the motor 2. Accordingly, the influence of the delay time Td from the output of the detection result of the position of the motor 2 by the position sensor 3 until the detection result is updated every control cycle can be reduced.

### Modified Example of First Embodiment

A modified example of the first embodiment will be described. In the first embodiment, a case has been described in which the change in the detected position during the update cycle Ts is calculated from the difference in the position information Qr of the detection result, and the change is set as the change amount ΔQr. Instead, in this modified example, a case will be described in which a moving average is used to calculate the change amount ΔQr.

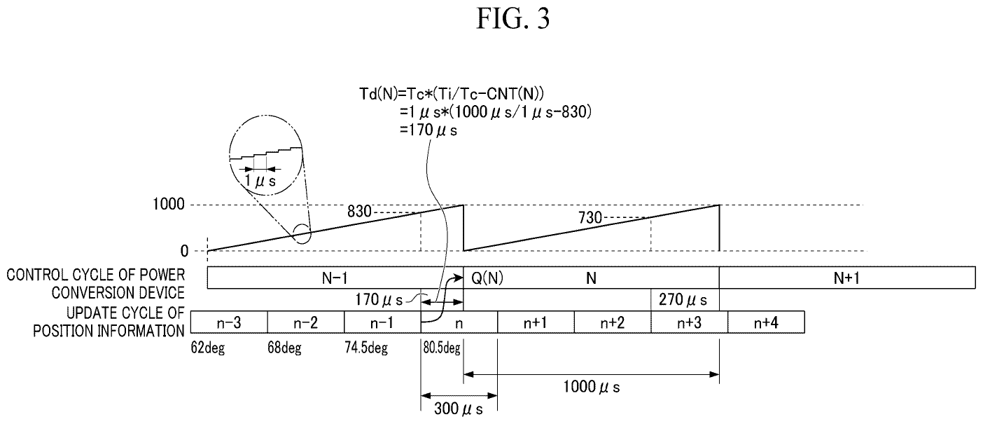

Referring to FIG. 3, the position compensation amount adjustment of the modified example of the first embodiment will be described.

FIG. 3 is a diagram for illustrating the position compensation amount adjustment of the modified example of the first embodiment.

Each information shown in FIG. 3 is the same as that in FIG. 2 described above. This figure discloses numerical examples of each variable when specific conditions are set.

### Modified Example of Deriving Compensation Amount for Delay Time Td:

In order to improve the accuracy of the compensation amount Qc, one method is to take a moving average in calculating the change amount ΔQr. The example below is a simple moving average. However, the present invention is not limited to a specific moving average method, and the number of moves can be arbitrary. The change amount ΔQr does not depend on the control cycle of the power conversion device 10, and it is preferable to decide the type of moving average method to be adopted and the length of the time window. This relationship is shown in the following formula (3).

$$\begin{matrix}[ Math 1 ] & \\ Δ Qr = [ {\sum }_{k = 1}^{m} \{ Qr ( n - ( k - 1 ) ) - Qr ( n - k ) \} ] / m & ( 3 )\end{matrix}$$

The variable m in the above formula (3) is a natural number indicating the number of update cycles included in the time window which defines the range of moving average processing. According to formula (3), the difference when changing the value of variable k from 1 to m, that is, the total value of (Qr(n−(k−1))−Qr(n−k)), is divided by m and then the change amount ΔQr is derived.

The calculation results using specific numerical values are shown below.
Control cycle of power conversion device 10: Ti=1000 μs
Phase update cycle: Ts=300 μs
Counter period: Tc=1 μs
Specifications of motor 2:60 Hz, 2-pole AC motor, rated rotation speed 3600 rpm
Acceleration conditions: Vehicle which is assumed to accelerate from 0 to 100% speed in 1 second.

In the above case, as shown in the following conversion formula, it rotates at a speed of “21.6°” per millisecond.

In this case, it can be seen that the phase rotates by “6.48°” within 300 μs (microseconds) of the phase update time Ts.

$$3600 rpm / 60 s = 60 rps$$

$$60 rps / 1000 ms = 0.06 r / ms$$

$$360 ° * 0.06 r / ms = 21.6 ° / ms$$

$$21.6 ° / ms * ( 300 μs / 1000 μs ) = 6.48 ° / ( 300 μs )$$

It is assumed that the position sensor 3 detects the following phase and notifies the power conversion device 10 of the phase.

$$Qr ( n - 3 ) = 62 °$$

$$Qr ( n - 2 ) = 68 °$$

$$Qr ( n - 1 ) = 74.5 °$$

$$Qr ( n ) = 80.5 °$$

A simple moving average with three elements (m=3) within the time window is used. The position change amount ΔQr in this case is calculated using the following formula. According to the calculation result, the change amount ΔQr in the position of the motor 2 is a rotation of “6.17°” within 300 μs of the phase update time Ts.

$$\begin{matrix}Δ Qr = \{ ( Qr ( n ) - Qr ( n - 1 ) ) + ( Qr ( n - 1 ) - Qr ( n - 2 ) ) + ( Qr ( n - 2 ) - Qr ( n - 3 ) ) \} / 3 \\ = \{ 6 + 6.5 + 6 \} / 2 \\ = 6.17 °\end{matrix}$$

On the other hand, if the counter CNT(N) is “830” when Qr(n) is “80.5°” as described above, the delay time Td(N) is “170 μs” as shown in the following formula.

$$\begin{matrix}Td ( N ) = Tc * ( Ti / Tc - CNT ( N ) ) \\ = 1 μs * ( 1000 μs / 1 μs - 830 ) \\ = 170 μs\end{matrix}$$

When analyzed using the numerical values of each variable above, the magnitudes of Qc(N) and Q(N) become “3.496°” and “84°”, respectively.

$$\begin{matrix}Qc ( N ) = Δ Qr * Td ( N ) / Ts \\ = 6.17 ° * 170 μs / 300 μs \\ = 3.496 °\end{matrix}$$

$$\begin{matrix}Q ( N ) = Qr ( n ) + Qc ( N ) \\ = 80.5 ° + 3.496 ° \\ = 84 °\end{matrix}$$

Furthermore, if the same conditions as above are applied to the comparative example, Q(N) will be “80.5° ”. This value is the value of Qr(n) before compensation, and the influence of the delay time Td can be reduced by applying this embodiment.

This modified example also has the same effects as the above-described embodiment. In addition to this, according to this modified example, it is possible to increase the resistance to accidental fluctuations included in the position detection results.

As described above, if the variation in the transmission delay of the phase information is relatively small, the position sensor 3 which outputs the position information Qr can be used on the side of the power conversion device 10.

Furthermore, the difference in position information Qr (change amount ΔQr) can be regarded as the phase change rate with respect to the update cycle Ts. This becomes a variable having dimensions equivalent to the rotation speed and frequency of the motor 2.

On the other hand, if the variation in the transmission delay of the phase information influences the control, it is preferable to calculate the difference (change amount ΔQr) in the position information Qr on the side of the position sensor 3.

### Second Embodiment

A second embodiment will be described. In the first embodiment, a case has been described in which the position sensor 3 periodically outputs the position information Qr and the power conversion device 10 calculates the difference (change amount ΔQr) in the position information Qr during the update cycle Ts. In this embodiment, an example in which the position sensor 3 periodically outputs the position information Qr and the difference (change amount ΔQr) in the position information Qr will be described by focusing on the differences from the first embodiment.

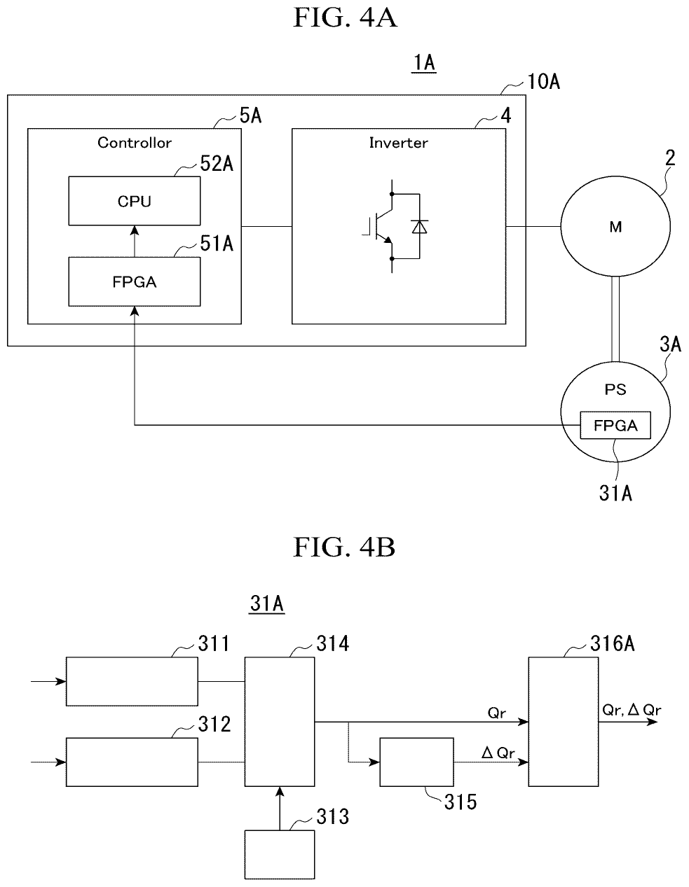

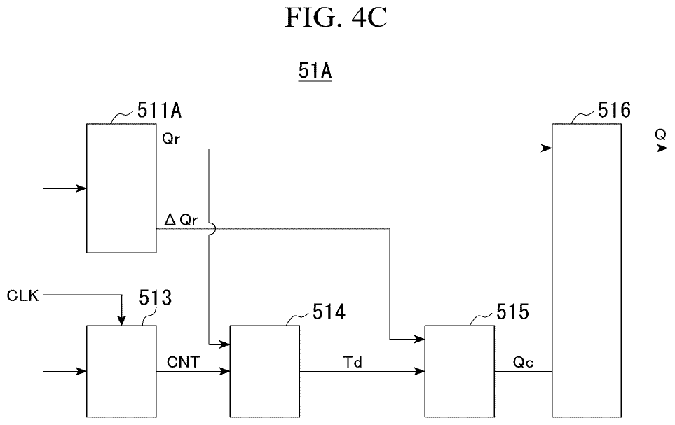

FIG. 4A is a configuration diagram of a motor drive system 1A of the second embodiment.

FIG. 4B is a configuration diagram of a calculation unit 31A of the second embodiment.

FIG. 4C is a configuration diagram of a compensation amount adjustment unit 51A of the second embodiment.

The motor drive system 1A includes, for example, the motor 2, a position sensor 3A, and a power conversion device 10A.

The position sensor 3A detects the absolute position of the shaft of the motor 2 similarly to the position sensor 3. The position sensor 3A further derives the absolute position change amount and outputs the absolute position change amount. Furthermore, unless otherwise specified, the first embodiment may be referred to by replacing the position sensor 3 of the first embodiment with the position sensor 3A.

As shown in FIG. 4B, the position sensor 3A includes a position sensor body and a calculation unit 31A (described as FPGA in FIG. 4A).

The calculation unit 31A of the position sensor 3A further includes a differential position information generation unit 315 in addition to the calculation unit 31 described above, and an output unit 316A instead of the output unit 316.

The differential position information generation unit 315 derives the position change amount ΔQr indicated by the position information Qr based on the position information Qr generated by the position information calculation unit 314. The differential position information generation unit 315 outputs this position change amount ΔQr in accordance with the timing at which the position sensor 3A outputs the position information Qr. Furthermore, the differential position information generation unit 315 may output the position change amount ΔQr as time history information.

The output unit 316A outputs the position information Qr and the position change amount ΔQr described above in association with each other.

Such a position sensor 3A preferably outputs time history information which associates the position information Qr with the position change amount ΔQr.

The power conversion device 10A is connected to the motor 2 and the position sensor 3A.

Furthermore, unless otherwise specified, the power conversion device 10 of the first embodiment may be read as the power conversion device 10A.

The power conversion device 10A includes the inverter 4 and a controller 5A.

The controller 5A includes, for example, a compensation amount adjustment unit 51A (described as FPGA in FIG. 4A) and the CPU 52.

Referring to FIG. 4C, an example of the compensation amount adjustment unit 51A of the controller 5A will be described.

The compensation amount adjustment unit 51A differs from the compensation amount adjustment unit 51 in that the compensation amount adjustment unit does not include a differential position information generation unit 512 and includes an interface 511A instead of the interface 511.

The interface 511A extracts the periodically transmitted position information Qr and the position change amount ΔQr from the signal from the position sensor 3A and outputs them. The position information Qr corresponds to the position information output by the position sensor 3. The position change amount ΔQr is supplied to the compensation amount calculation unit 515.

Furthermore, the compensation amount calculation unit 515 of this embodiment acquires the phase change amount ΔQr for each update cycle Ts from the interface 511A. Similarly to the first embodiment, the compensation amount calculation unit 515 calculates the compensation amount Qc of the position information Qr using the delay time Td and the phase change amount ΔQr for each update cycle Ts.

In this way, even when calculating the position change amount ΔQr within the position sensor 3A, the same effects as in the first embodiment can be achieved.

Furthermore, since the differential position information generation unit 315 is disposed in the position sensor 3A instead of the differential position information generation unit 512, the position change amount ΔQr generated by the differential position information generation unit 315 is less susceptible to the variation in the transmission delay of the phase information.

### Third Embodiment

A third embodiment will be described. In the first and second embodiments, a case has been described in which the position of the motor 2 is defined in the range of 0 to 360°. Instead, in this embodiment, a case will be described in which the position is defined in the range of −180° to +180°.

If the position of the motor 2 is defined in the range of 0 to 360°, the value indicating the position returns to 0° after one rotation. Therefore, if the previous value is simply subtracted from the current position value, the value of the change amount ΔQr may deviate greatly from the normal value.

In such a case, one rotation of 360° is determined by using the range of −180° to +180° and its polarity to define calculation rules which are divided into conditions. When the current position value and the previous position value are at a boundary where the polarity changes, it is preferable to separate the processing using conditional branching.

For example, when the polarity of the position difference changes from negative to positive, the following formula (4) is satisfied, and in this case, formula (5) is used.

$$Qr ( n - 1 ) < 0 ⋀ Qr ( n ) > 0 \qquad ( 4 )$$

$$Δ Qr = 180 ° + Qr ( n ) - \vert Qr ( n - 1 ) \vert \qquad ( 5 )$$

Further, when the polarity of the position difference changes from positive to negative, the following formula (6) is satisfied, and in this case, formula (7) is used.

$$Qr ( n - 1 ) > 0 ⋀ Qr ( n ) < 0 \qquad ( 6 )$$

$$Δ Qr = - ( 180 ° + \vert Qr ( n ) \vert - Qr ( n - 1 ) ) \qquad ( 7 )$$

By using the calculation rules divided into conditions in this way, it is possible to prevent the value of the change amount Δfrom deviating greatly from the normal value.

The above embodiment can be combined with the first and second embodiments described above.

According to at least one embodiment described above, in the motor drive system 1 in which the delay time occurs from the first timing of updating the detection result of the position of the motor 2 using the position sensor by outputting the detection result of each position of the motor in each first period to the second timing of acquiring in formation on the position of the motor 2 in each second period within the control cycle of the motor, the influence of the delay time Td from the output of the detection result of the position of the motor by the position sensor until the detection result is updated every control cycle can be reduced. In the above case, the motor drive system may include a compensation amount adjustment unit which counts the time (time difference) from the first timing to the second timing and generates a compensation value for compensating for the position information based on the counting result and a control unit which performs position control on the motor based on the position information as a result of compensation and the position command information of the motor.

Some or all of the functional units of the controllers 5 and 5A and the position sensors 3 and 3A in the motor drive systems 1 and 1A of the embodiments described above may include, for example, a software functional unit which is realized when a program (computer program, software component) stored in a storage unit (memory, etc.) of the computer is executed by a processor (hardware processor) of the computer. Furthermore, some or all of the functional units of the controllers 5 and 5A and the position sensors 3 and 3A may be realized by hardware such as Large Scale Integration (LSI), Application Specific Integrated Circuit (ASIC), or Field-Programmable Gate Array (FPGA), or by a combination of software functional units and hardware.

Although several embodiments of the invention have been described, these embodiments are presented by way of example and are not intended to limit the scope of the invention. These embodiments can be implemented in various other forms, and various omissions, substitutions, and changes can be made without departing from the gist of the invention. For example, the configurations of each embodiment may be implemented in combination with each other, and may be applied to component parts whose description is omitted. These embodiments and their modified examples are included within the scope and gist of the invention as well as within the scope of the invention described in the claims and its equivalents.

### REFERENCE SIGNS LIST

1, 1A Motor drive system
2 Motor
3, 3A Position sensor
4 Inverter
5, 5A Controller
10, 10A Power conversion device
31, 31A Calculation unit
51, 51A Compensation amount adjustment unit

1. A motor drive system in which a delay time occurs from a first timing of updating a detection result of a position of a motor using a position sensor by outputting the detection result of each position of the motor in each first period from the position sensor to a second timing of acquiring position information of the motor in each second period within a control cycle of the motor, the motor drive system comprising:
a compensation amount adjustment unit which counts time from the first timing to the second timing and generates a compensation value for compensating for the position information based on the counting result; and
a control unit which performs position control on the motor based on the position information as a result of compensation and position command information of the motor.

2. The motor drive system according to claim 1,
wherein the compensation amount adjustment unit compensates for the detection result in response to a size of a time difference from the first timing to the second timing.

3. The motor drive system according to claim 2,
wherein the compensation amount adjustment unit compensates for the detection result using the size of the time difference from the first timing to the second timing and time history information of the position of the motor at the first timing.

4. The motor drive system according to claim 2,
wherein the compensation amount adjustment unit is provided in any one of the motor drive system for driving the motor and the position sensor.

5. The motor drive system according to claim 3,
wherein the compensation amount adjustment unit generates a compensation value based on the counting result, compensates for the detection result using the compensation value, and generates position information of the compensated result.

6. The motor drive system according to claim 1,
wherein the lengths of the first period and the second period are not equal to each other.

7. The motor drive system according to claim 1,
wherein the compensation amount adjustment unit generates a compensation value based on the counting result and generates position information of the compensated result using the compensation value and time history information of the position of the compensated result.

8. A motor drive method of using a power conversion device in which a delay time occurs from a first timing of updating a detection result of a position of a motor using a position sensor in each first period to a second timing of acquiring position information of the motor in each second period within a control cycle of the motor, the motor drive method comprising:
counting time from the first timing to the second timing and generating a compensation value for compensating for the position information based on the counting result; and
performing position control on the motor based on the position information as a result of compensation and position command information of the motor.

9. The motor drive method according to claim 8,
wherein the detection result is compensated in response to a size of a time difference from the first timing to the second timing.

10. The motor drive method according to claim 9,
wherein the detection result is compensated using the size of the time difference from the first timing to the second timing and time history information of the position of the motor at the first timing.

11. The motor drive method according to claim 9,
wherein any one of the power conversion device for driving the motor and the position sensor generates a compensation value for compensating for the position information.

12. The motor drive method according to claim 10,
wherein a compensation value is generated based on the counting result, the detection result is compensated using the compensation value, and position information of the compensated result is generated.

13. The motor drive method according to claim 8,
wherein the lengths of the first period and the second period are not equal to each other.

14. The motor drive method according to claim 8,
wherein a compensation value is generated based on the counting result and position information of the compensated result is generated using the compensation value and time history information of the position of the compensated result.
